(19) United States
(12) Patent Application Publication
(10) Pub. No.: US 2021/0122456 A1
(43) Pub. Date: Apr. 29, 2021

(54) SEAL FOR AN AIRCRAFT

(71) Applicant: Airbus Operations S.L.U., Getafe (ES)

(72) Inventor: Angel GARCIA-SACRISTAN, Getafe (ES)

(21) Appl. No.: 17/081,234

(22) Filed: Oct. 27, 2020

(30) Foreign Application Priority Data
Oct. 29, 2019 (EP) 19382944.7

(51) Int. Cl. B64C 7/00; F16J 15/02

(52) U.S. Cl. CPC B64C 7/00; F16J 15/022

(57) ABSTRACT

A seal for an aircraft, the seal including an elongated body comprising a Y-shaped cross-section with two legs. The seal is configured to be fixed to a fairing of the aircraft and configured to be applied against the surface of a lifting surface of the aircraft. The seal further comprises a flexible connection extending between the two legs.

### CROSS-REFERENCES TO RELATED APPLICATIONS

This application claims the benefit of the European patent application No. 19382944.7 filed on Oct. 29, 2019, the entire disclosures of which are incorporated herein by way of reference.

### FIELD OF THE INVENTION

The invention relates to a seal for an aircraft. The invention specifically refers to a seal located between an aircraft fairing and the surface of a lifting surface. More specifically, the seal of the invention may be configured for a gap between a wing upper cover and panels of the upper belly fairing in the Karman area.

### BACKGROUND OF THE INVENTION

It is known to seal with aerodynamic seals the gap existing between the wing upper covers and the panels of the upper belly fairing in the Karman area. The seal ensures the surface of the aircraft remains aerodynamic.

The mentioned gap between the wing upper covers and the panels of the upper belly fairing is not constant. The gap varies with the different flight conditions. The gap is larger when the aircraft is on the ground than during flight. With a seal installed in the gap, this results in a minimum seal compression when the aircraft is on the ground and a maximum seal compression during flight. For this reason, the seal shall be flexible enough to seal the gap in all flight conditions.

Therefore, in addition to its tightness function, the seal should absorb the relative movements between the fairing, on the one hand, and the lifting surface, on the other hand.

Flexible is to be interpreted as capable of being flexed, i.e., the seal is capable of being repeatedly bent.

Currently, these seals comprise an elongated body comprising a Y-shaped cross-section having two legs. The seal is attached, for instance riveted, to the belly fairing panels and rests against the surface of the wing on both legs. Known Y-section seals are made of silicone rubber with an internal reinforcement of glass fabric and externally covered and reinforced with a polyester fabric, with an external low friction polyester impregnated woven fabric.

The above described seals may be damaged after a certain number of flights due to the aerodynamic and differential pressure loads, resulting in in-service annoyance (noise in the cabin). Typical examples of damage of these seals are the tearing of the seal in the forward end of the seal and the breaking of the edge of the seal, both damages occurring on the outer leg of the seal, i.e., the leg farthest away from the fuselage. Such seals, when damaged, must be replaced.

It is known that one solution to reduce the risk of damage in such Y-shaped seals is to fill the space between the two legs of the seal with sealant, but this is more a ‘repair’ solution than a ‘design’ solution. The above indicated solution is not totally effective as it depends on the quality of the sealing process. If the sealant is broken the seal may eventually fail, as indicated in the previous paragraph. Additionally, the sealant results in a weight penalty for the aircraft.

Furthermore, it is necessary to remove the belly fairing panels, for maintenance or repair operations. Thus, another drawback is that the sealant must be cut and removed prior to the removal operation. Additionally, before the installation of the belly fairing panels, the area of the wing may have traces of sealant that has to be cleaned.

### SUMMARY OF THE INVENTION

A first object of the invention is a seal for an aircraft, this seal is of the kind that comprises an elongated body comprising a Y-shaped cross-section, i.e., the seal is a body with more length than width in proportion and having a cross-section with two legs and an additional branch located approximately opposite to the bisector of the two legs.

The seal is configured to be fixed to a fairing of the aircraft and to be applied or to rest against the surface of a lifting surface of the aircraft, for instance, a wing, for performing its sealing function of the gap existing between the two elements.

In an embodiment, the seal may be fixed to the fairing through the additional branch and the two legs may be applied against the surface of the lifting surface.

The claimed seal comprises a flexible connection extending or spanning between the two legs, thus joining both legs. Flexible is understood in this application as an element capable of being flexed, i.e., the connection is capable of being bent, especially repeatedly. The connection is thus able to be flexed according to the seal requirements and according to the loads to which it is exposed. The connection shape will be changed due to the relative movements of the fairing and the lifting surface during flight conditions.

The flexible connection will limit the separation between both legs to the length of the flexible connection, when the seal is deformed. More specifically, the length of the flexible connection may be defined to ensure that the reaction load developed by the flexible connection on the legs prevents the lift of the edge of the outer leg of the seal.

Therefore, the claimed invention has the main advantage that the sealant is avoided, also having the additional following advantages over the use of a sealant located between the two legs:

Less weight of the seal.

Maintenance and removal or replacement of the belly fairing panels is easier as the seal is not glued to the wing and, thus, it reduces the time required for these operations.

It is also an object of the invention to provide an aircraft comprising a lifting surface and a fairing, the lifting surface and the fairing defining a gap between them, the aircraft further comprising a seal located in the gap, the seal comprising an elongated body comprising a Y-shaped cross-section with two legs. The elongated body is being fixed to the fairing and being applied against the surface of the lifting surface, the seal further comprising a flexible connection extending between the two legs.

### BRIEF DESCRIPTION OF THE DRAWINGS

To complete the description and in order to provide for a better understanding of the invention, a set of drawings is provided. The drawings form an integral part of the description and illustrate preferred embodiments of the invention. The drawings comprise the following figures.

FIG. 1 shows a schematic cross section of a known seal and its attachment to the Karman panel of the belly fairing.

FIG. 2 shows a schematic cross section of a known seal filled with sealant between the two legs.

FIG. 3 shows a cross section of an embodiment of the seal installed in the panel of the belly fairing.

FIG. 4 shows a cross section of the embodiment of the seal corresponding to FIG. 3 in a cruise condition of the aircraft.

FIG. 5 shows a detail of the ends of one of the legs of the seal corresponding to FIG. 4.

FIG. 6 shows a schematic lateral view of the embodiment of two contiguous seals.

FIG. 7 shows a perspective view of a seal according to the embodiment shown in FIG. 6.

FIG. 8 shows an aircraft and the location of a belly fairing Karman panel in the upper side of a wing.

FIG. 9 shows a schematic cross section of an embodiment of the seal with reinforcements.

### DETAILED DESCRIPTION OF THE PREFERRED EMBODIMENTS

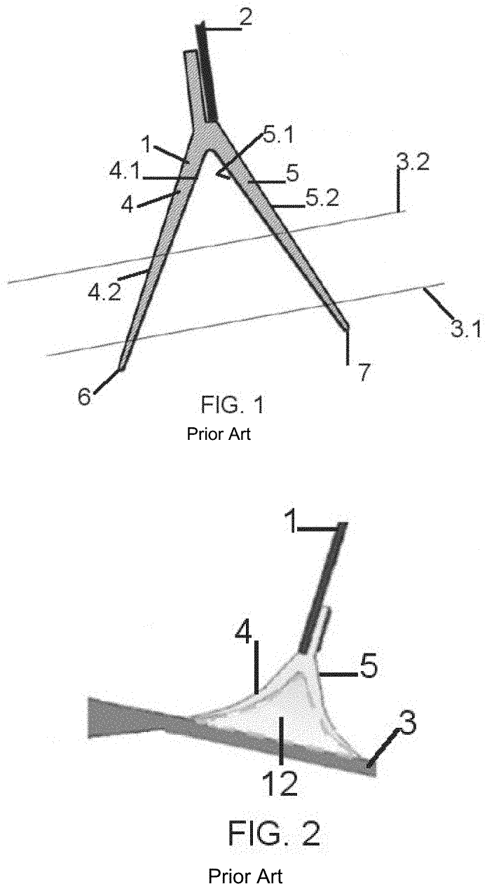

FIG. 1 shows a known seal (1) and its attachment to the fairing (2), specifically to the Karman panel of the belly fairing. The seal (1) further rests or is applied to the surface (3.1, 3.2) of a lifting surface (3), specifically a wing, through the two legs (4, 5) of its Y-shaped cross-section. The wing surface (3.1, 3.2) may have different positions between two limit positions. The first limit position corresponds to the nominal position in which the aircraft is on ground and the gap between the belly fairing (2) and the wing surface (3.1) is wider. The second limit position corresponds to the cruise position of the aircraft wherein the gap between the belly fairing (2) and the wing surface (3.1) is narrower. The ends (6, 7) of the legs (4, 5) would rest on the wing surface (3.1, 3.2) and the legs (4, 5) would deform according to the position the surface (3.1, 3.2).

Each leg (4, 5) comprises two opposite sides, an inner side (4.1, 5.1) facing the other leg (4, 5) and an outer side (4.2, 5.2) opposite to the inner side (4.1, 5.1).

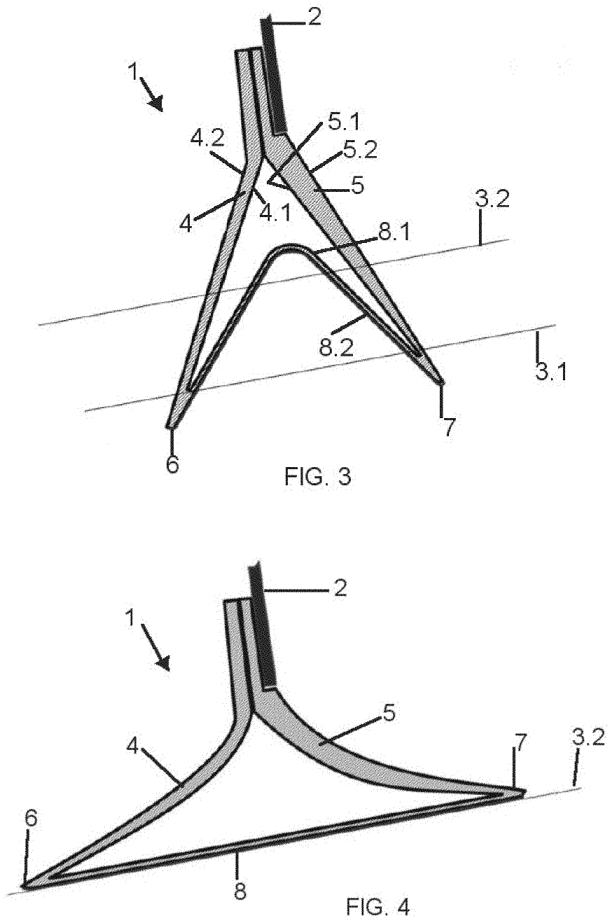

Similarly, as shown in the embodiment of FIG. 3, the flexible connection (8) may also comprise two sides (8.1, 8.2), an inner side (8.1) located towards the two legs (4, 5) and an outer side (8.2) opposite to the inner side (8.1).

FIG. 2 shows a seal (1) filled with sealant (12) between the two legs (4, 5) of the seal (1) as explained in the state of the art.

FIG. 3 discloses an embodiment of the invention. Each of the legs (4, 5) has an end (6, 7) and the seal (1) comprises the flexible connection (8) extending between those ends (6, 7), free ends (6, 7), of the two legs (4, 5).

In this embodiment, the flexible connection (8) is further joined to the legs (4, 5) via the inner sides (4.1, 5.1) of the ends (6, 7).

As the seal (1) comprises an elongated body, in an embodiment, the flexible connection (8) spans along the length of the elongated body of the seal (1). Alternatively, in another embodiment, instead of extending the full length of the elongated body of the seal (1), the flexible connection (8) may extend just a portion of its length.

A flexible connection (8) spanning along the length of the elongated body of the seal (1) has the advantage that, firstly, it is easier to manufacture and, secondly, loads are better distributed along the length of the seal (1).

In an embodiment, the flexible connection (8) comprises silicone rubber and additionally, the inner side (8.1) of the flexible connection (8) may comprise a covering layer of glass fabric covering the inner side (8.1).

The outer side (8.2) of the flexible connection (8) may comprise a covering layer of polyester fabric.

Additionally, the outer side (8.2) of the flexible connection (8) may comprise a covering layer of a low friction polyester impregnated woven fabric.

Therefore, in an embodiment the flexible connection (8) may comprise silicone rubber, an inner side of a covering layer of glass fabric, an outer side of a covering layer of polyester fabric and a further covering layer of a low friction polyester impregnated woven fabric.

Additionally, at least one of the legs (4, 5) comprises a reinforcement (9) extending in a cross-section from the end (6, 7) of the leg along a portion of the length of the leg (4, 5). Thus, the reinforcement (9) is located at the end (6, 7) of at least one leg (4, 5). It improves the stiffness of the leg (4, 5) of the seal (1) to ensure its proper functioning. In the shown embodiment, both legs (4, 5) comprise the mentioned reinforcement (9).

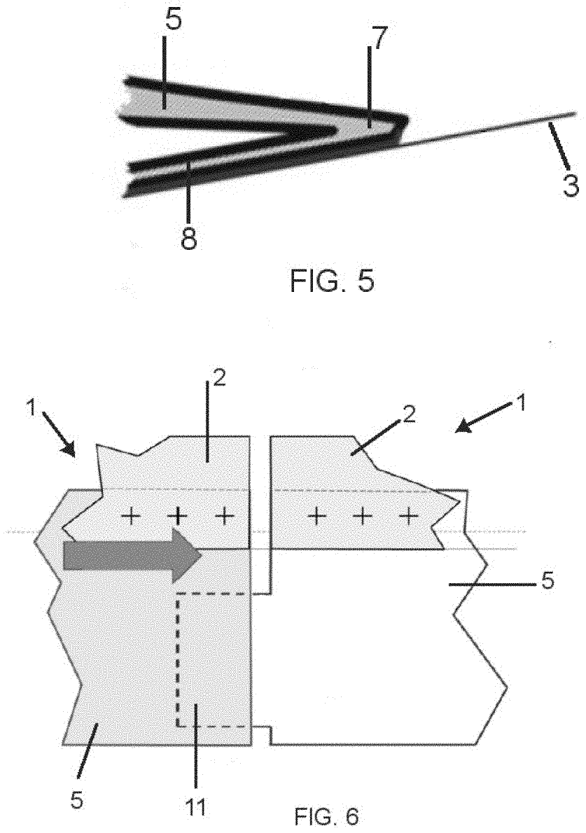

Preferably, the length of the flexible connection (8) in a cross-section of the seal (1) is such that, in cruise condition of the aircraft, the flexible connection (8) supports tension loads coming from the legs (4, 5) due to the separation between both legs (4, 5). Thus, the flexible connection (8) is in tension while the legs (4, 5) are under compression loads as shown in FIGS. 4 and 5. The flexible deformation of the seal (1) results in an flexible load that pushes the edges (6, 7) of the seal (1) against the wing surface (3.1, 3.2) and counteracts the lift load, due to the aerodynamic loads, in the edge (6, 7) of the seal (1).

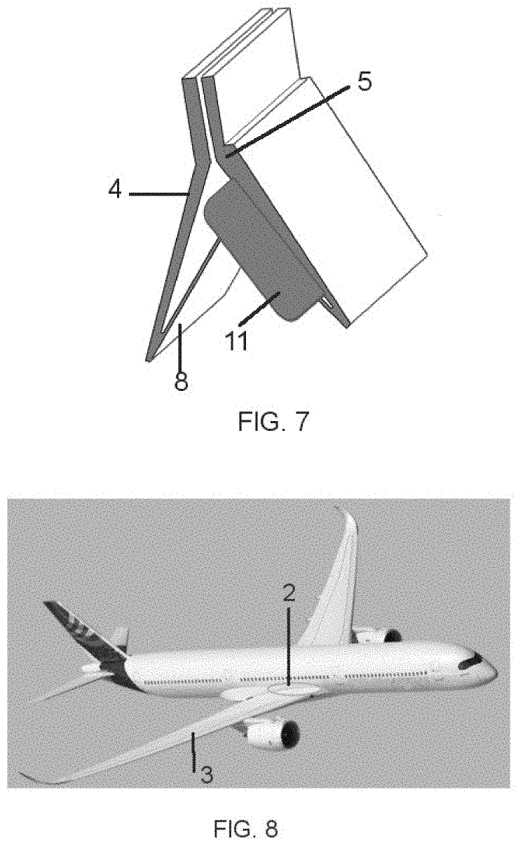

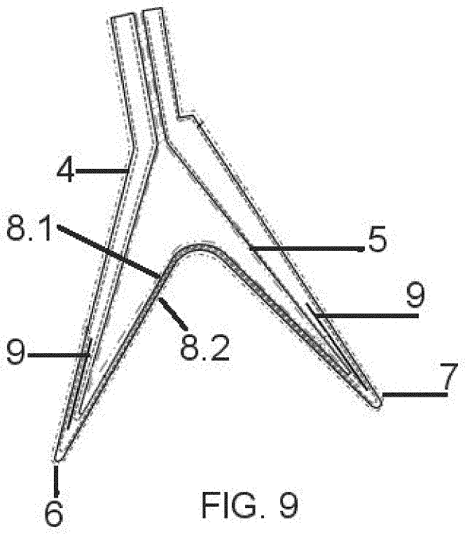

In the embodiments shown in FIGS. 6 and 7, the seal (1) comprises a tab (11) extending or protruding from one of the legs (4, 5) in the longitudinal direction of the seal (1).

A key issue in the aerodynamic seals (1) is to provide additional support and continuity. The longitudinal ends of the seals (1) are their weakest points. For solving this, the tab (11) may be covered by the leg (4, 5) of a contiguous seal (1) for continuity purposes. Specifically, the tab (11) is located in the outer leg (5), i.e., the leg (5) that is configured to be located farthest away from the fuselage. This outer leg (5) will be in contact with the flowing airflow. The tab (11) will be configured to be underneath the outer leg (5) of a seal (1) located upstream.

Finally, FIG. 8 shows an aircraft comprising a lifting surface (3) and a fairing (2), the lifting surface (3) and the fairing (2) defining a gap between them wherein a seal according to the invention is located.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A seal for an aircraft, the seal comprising:
an elongated body comprising a Y-shaped cross-section with two legs,
the seal being configured to be fixed to a fairing of the aircraft and configured to be applied against a surface of a lifting surface of the aircraft,
wherein the seal further comprises a flexible connection extending between the two legs.

2. The seal for an aircraft, according to claim 1, wherein the two legs each have an end and the flexible connection extends between the ends of the two legs.

3. The seal for an aircraft, according to claim 1, wherein the flexible connection spans along a length of the elongated body.

4. The seal for an aircraft, according to claim 1, wherein each leg comprises two opposite sides, an inner side facing the other leg and an outer side opposite to the inner side, the flexible connection being joined to the inner sides of the legs.

5. The seal for an aircraft, according to claim 1, wherein a length of the flexible connection in a cross-section of the seal is configured such that, in a cruise condition of the aircraft, the flexible connection supports tension loads due to a separation between both legs.

6. The seal for an aircraft, according to claim 1, further comprising a tab extending from one of the legs in a longitudinal direction of the elongated body of the seal.

7. The seal for an aircraft, according to claim 6, wherein the tab is configured to be covered by a leg of a contiguous seal.

8. The seal for an aircraft, according to claim 1, wherein the flexible connection comprises silicone rubber.

9. The seal for an aircraft, according to claim 1, wherein the flexible connection comprises two sides, an inner side located towards the two legs and an outer side opposite to the inner side, the inner side of the flexible connection comprising a covering layer of glass fabric.

10. The seal for an aircraft, according to claim 1, wherein the flexible connection comprises two sides, an inner side located towards the two legs and an outer side opposite to the inner side, the outer side of the flexible connection comprising a covering layer of polyester fabric.

11. The seal for an aircraft, according to claim 1, wherein the flexible connection comprises two sides, an inner side located towards the two legs and an outer side opposite to the inner side, the outer side of the flexible connection comprising a covering layer of a low friction polyester impregnated woven fabric.

12. The seal for an aircraft, according to claim 1, further comprising a reinforcement of at least one leg, the reinforcement extending in a cross-section from the ends along a portion of a length of the legs.

13. The seal for an aircraft, according to claim 12, wherein a material of the reinforcement is glass fiber or polyester.

14. An aircraft comprising:
a lifting surface and
a fairing,
the lifting surface and the fairing defining a gap between them, a seal located in the gap,
the seal comprising
an elongated body comprising a Y-shaped cross-section with two legs,
the elongated body fixed to the fairing and applied against the surface of the lifting surface,
wherein the seal further comprises a flexible connection extending between the two legs according to claim 1.
